(19) United States
(12) Patent Application Publication
(10) Pub. No.: US 2017/0148191 A1
(43) Pub. Date: May 25, 2017

(54) DISPLAY METHOD AND DISPLAY DEVICE

(71) Applicants: Le Holdings (Beijing) Co., Ltd., Beijing (CN); Lemobile Information Technology (Beijing) Co., Ltd., Beijing (CN)

(72) Inventor: Qin HUANG, Beijing (CN)

(21) Appl. No.: 15/247,370

(22) Filed: Aug. 25, 2016

Related U.S. Application Data
(63) Continuation of application No. PCT/CN2016/085544, filed on Jun. 13, 2016.

(30) Foreign Application Priority Data
Nov. 20, 2015 (CN) 201510810864.4
Jun. 13, 2016 (CN) PCT/CN2016/085544

(51) Int. Cl. G06T 11/00; G09G 5/377

(52) U.S. Cl. CPC G06T 11/001; G09G 5/377; G09G 2320/066

(57) ABSTRACT

The present disclosure provides a display method and a display device. The method includes: receiving a picture sent by a user for being displayed in a first display layer; overlapping the picture and a second display layer including icons; when the color contrast of the icon in a first area of the second display layer being overlapped onto the picture displayed in a first area of the first display layer is less than a first preset threshold, adjusting the color contrast in the first area, so that the adjusted color contrast is greater than a second preset threshold, the second threshold being greater than or equal to the first threshold. The present disclosure solves the problem of the prior art that a functional icon cannot be recognized by a user when the colors of the background picture and the functional icon are consistent, improves the display visibility of the icon.

### CROSS REFERENCE TO RELATED APPLICATIONS

This application is a continuation of International Application No. PCT/CN2016/085544, filed on Jun. 13, 2016, which is based upon and claims priority to Chinese Patent Application No. 201510810864.4, filed on Nov. 20, 2015, the entire contents of which are incorporated herein by reference.

### TECHNICAL FIELD

The embodiments of the present disclosure relate to the field of electronic technology, and, more particularly, to a display method and a display device.

### BACKGROUND

With the gradually increasing image processing ability of an intelligent terminal in hardware aspect, and more and more higher requirements of users on the user interface (English: User Interface; abbreviation: UI) display ability of the intelligent terminal, more display effects are added into a display application of the intelligent terminal. For example: the users are allowed to change desktop background pictures of the intelligent terminal according to the hobbies thereof.

However, the UI of the intelligent terminal includes at least two display layers: a first display layer and a second display layer. Wherein, the first display layer is used for displaying the desktop background pictures set by the users; therefore, the first display layer may also be called as a background display layer. FIG. 1(a) is a background picture configured by a system, and the background picture of the intelligent terminal may be a picture having a single-color, for example: a blue picture or a black picture, etc. The background picture may also be a picture that includes specific contents. The second display layer is used for displaying various icons configured by the system, as shown in FIG. 1(b), for example: a time icon, an alarm clock icon, an APP icon, etc.

During practical application, the second display layer is generally divided into two display areas: a first display area and a second display area. Wherein, the first display area is used for displaying general icons configured by the system, for example: a time icon, a signal strength icon, an electric quantity icon, an alarm clock icon, or the like. These icons are relatively fixed; therefore, the first display area may also be called as a notification bar display area. The second display area is used for displaying the APP icons of APPs installed on the intelligent terminal. These icons are relatively flexible; therefore, the second display area may also be called as an application display area.

The at least two display layers included in the UI are displayed in an overlapping manner. Generally, the second display layer may also be called as a transparent layer. When designing the display of the UI, the second display layer is usually located above the first display layer; in this way, when viewing various icons displayed in the second display layer, the background picture displayed in the first display layer may also be seen through the second display layer, i.e., the user interface configured by the system as shown in FIG. 1(c).

It is found by the inventor during the process of implementing the present disclosure that: During practical application, because the colors of various icons of the second display layer are pre-configured by the system, which are relatively fixed, once the user determines the background picture displayed in the first display layer, when the color of the background picture displayed in the first display layer determined is closer to the color of the icon displayed in the second display layer, the user cannot recognize the icon displayed in the second display layer, which reduces the efficiency of the user for viewing the icon displayed in the second display layer, and brings inconvenience when the user is using the intelligent terminal.

For example: FIG. 1(d) shows a user interface that the user participates in configuration. It may be seen from FIG. 1(d) that the FIG. 1(c) differs from FIG. 1(d) in the background picture; moreover, the contents of circled parts in the figures can been seen in FIG. 1(c), but cannot be recognized in FIG. 1(d).

### SUMMARY

The embodiments of the present disclosure provide a display method and a display device, for solving the problem in the prior art that a functional icon cannot be recognized when the color of the background picture is closer to the color of the functional icon.

The embodiment of the present disclosure provides a display layer display method, including:

receiving a picture sent by a user for being displayed in a first display layer;

performing display overlapping on the picture and a second display layer including icons;

when the color contrast of the icon in a first area of the second display layer being overlapped onto the picture displayed in the first area of the first display layer is less than a first preset threshold, adjusting the color contrast in the first area, so that the adjusted color contrast is greater than a second preset threshold, the second threshold being greater than or equal to the first threshold; and

displaying the first display layer including the pictures and the second display layer including the icons into a user interface UI in an overlapping manner according to the adjustment result.

The embodiment of the present disclosure also provides a display layer display device, including:

a receiving unit configured to receive a picture sent by a user for being displayed in a first display layer;

an adjustment unit configured to perform display overlapping on the picture and a second display layer including icons; and when the color contrast of the icon in a first area of the second display layer being overlapped onto the picture displayed in the first area of the first display layer is less than a first preset threshold, adjust the color contrast in the first area, so that the adjusted color contrast is greater than a second preset threshold, the second threshold being greater than or equal to the first threshold; and

a display unit configured to display the first display layer including the pictures and the second display layer including the icons into a user interface UI in an overlapping manner according to the adjustment result.

The embodiment of the present disclosure also provides a display device, including: a memory and a processor; wherein the memory is stored with an instruction of implementing the display method according to any one of claims 1 to 8, and the processor includes a graphic processing unit;

the following steps may be performed when the processor invokes the instruction of the display method stored in the memory:

receiving a picture sent by a user for being displayed in a first display layer;

performing display overlapping on the picture and a second display layer including icons;

when the color contrast of the icon in a first area of the second display layer being overlapped onto the picture displayed in the first area of the first display layer is less than a first preset threshold, adjusting the color contrast in the first area, so that the adjusted color contrast is greater than a second preset threshold, the second threshold being greater than or equal to the first threshold; and

displaying the first display layer including the pictures and the second display layer including the icons into a user interface UI in an overlapping manner according to the adjustment result.

The display method and the display device provided by the embodiments of the present disclosure receive the picture sent by the user for being displayed in the first display layer; perform display overlapping on the picture and the second display layer including the icon; when the color contrast of the icon in the first area of the second display layer being overlapped onto the picture displayed in the first area of the first display layer is less than the first preset threshold, adjust the color contrast in the first area, so that the adjusted color contrast is greater than the second preset threshold, the second threshold being greater than or equal to the first threshold; and display the first display layer including the pictures and the second display layer including the icons into the user interface UI in an overlapping manner according to the adjustment result. In this way, for the same display area, when the color of the picture displayed in the first display layer and the color of the icon displayed in the second display layer are consistent, the color of the picture and/or the color of the icon is adjusted flexibly, so that the color contrast between the color of the picture and the color of the icon is increased, the display visibility of the icon is improved, the problem that the icon cannot be recognized by the user when the color of the picture displayed in the first display layer is consistent with the color of the icon displayed in the second display layer is solved, and the flexibility of the user for operating the intelligent terminal is increased.

### BRIEF DESCRIPTION OF THE DRAWINGS

The drawings illustrated herein are intended to provide further understanding of the present disclosure, constituting a part of the present application. Exemplary embodiments and explanations of the present disclosure here are only for explanation of the present disclosure, but are not intended to limit the present disclosure. In the drawings:

FIG. 1(a) is a schematic diagram illustrating a first display layer used for displaying a desktop background picture set by a user in the prior art;

FIG. 1(b) is a schematic diagram illustrating a second display layer used for displaying various icons configured by a system on the “desktop background picture of FIG. 1(a)” in the prior art;

FIG. 1(c) is a schematic diagram illustrating a user interface configured by the system in the prior art;

FIG. 1(d) is a schematic diagram illustrating a user interface that the user participates in configuration in the prior art;

FIG. 2 is a schematic diagram illustrating a flow of a display method provided by the embodiments of the present disclosure;

FIG. 3 is a schematic diagram for displaying pictures and icons in an UI in an overlapping manner according to adjustment results;

FIG. 4 is a structural schematic diagram of a display device provided by the embodiments of the present disclosure;

FIG. 5 is a structural schematic diagram of a display device provided by the embodiments of the present disclosure; and

FIG. 6 is a schematic diagram illustrating a user interface of a display device provided by the embodiments of the present disclosure.

### DETAILED DESCRIPTION

To make the objects, technical solutions and advantages of the embodiments of the present disclosure more clearly, the technical solutions of the present disclosure will be clearly and completely described hereinafter with reference to the embodiments and drawings of the present disclosure. Apparently, the embodiments described are merely partial embodiments of the present disclosure, rather than all embodiments. Other embodiments derived by those having ordinary skills in the art on the basis of the embodiments of the present disclosure without going through creative efforts shall all fall within the protection scope of the present disclosure.

The embodiments of the present disclosure provide a display method and a display device which receive a picture sent by a user for being displayed in a first display layer; perform display overlapping on the picture and a second display layer including icons; when the color contrast of the icon in a first area of the second display layer being overlapped onto the picture displayed in the first area of the first display layer is less than a first preset threshold, adjust the color contrast in the first area, so that the adjusted color contrast is greater than a second preset threshold, the second threshold being greater than or equal to the first threshold; and display the first display layer including the pictures and the second display layer including the icons into a user interface UI in an overlapping manner according to the adjustment result. In this way, for the same display area, when the color of the picture displayed in the first display layer and the color of the icon displayed in the second display layer are consistent, the color of the picture and/or the color of the icon is adjusted flexibly, so that the color contrast between the color of the picture and the color of the icon is increased, the display visibility of the icon is improved, the problem that the icon cannot be recognized by the user when the color of the picture displayed in the first display layer is consistent with the color of the icon displayed in the second display layer is solved, and the flexibility of the user for operating the intelligent terminal is increased.

It should be noted that the color contrast described in the embodiments of the present application refer to the degree of closeness between different colors. An RGB (i.e., red, green and blue) manner is adopted for representing colors usually. When judging the degree of closeness between different colors, it is desirable to convert the RGB manner into an HSB/HSV manner. Wherein, the HSB/HSV manner mainly includes: hues (hues), saturation (saturation) and brightness (brightness/value).

That is, the colors are represented through the three elements including hues/saturation/brightness. Wherein, the hues represent the type of the color (for example: red, green or yellow), having a value range of 0˜360 degrees, and each value represents one color; the saturation represents the purity of the color, having a value range of 0˜1; and the brightness represents the degree of brightness of the color, having a value range of 0˜1.

It may be found through an HSB/HSV color space model that the hues, saturation and brightness of the color are linearly changed visually, then the color contrast between different colors may be determined by setting thresholds for the hues, saturation and brightness. If all the hues, saturation and brightness of two different colors satisfy the preset thresholds, then the color contrast of the two colors may be deemed to be closer mutually.

For example: it is provided that the set threshold of the hues is ±5, the set threshold of the saturation is ±0.2, the set threshold of the brightness is ±0.2, the hue of a color 1 is 1, the saturation of the color 1 is 0.1, and the brightness of the color 1 is 0.1; the hue of a color 2 is 3, the saturation of the color 2 is 0.05, and the brightness of the color 2 is 0.05, then through comparison, it is determined that the color contrast of the color 1 and the color contrast of the color 2 are closer to each other.

Further illustrative explanations will be made clearly and completely to the technical solutions in various embodiments of the disclosure hereinafter with reference to the accompanying drawings in the embodiments of the present disclosure. Apparently, the embodiments described are merely partial embodiments of the present disclosure, rather than all embodiments. Other embodiments derived by those having ordinary skills in the art on the basis of the embodiments of the present disclosure without going through creative efforts shall all fall within the protection scope of the present disclosure.

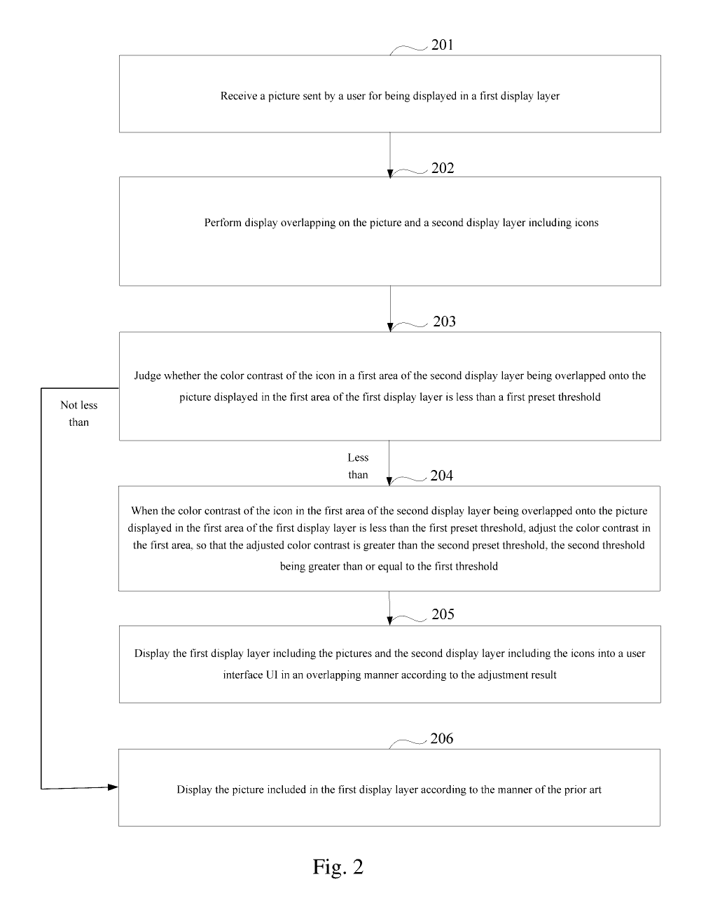

FIG. 2 is a schematic diagram illustrating a flow of a display method provided by the embodiment of the present disclosure. The method may be described as follows. An executive body of the embodiment of the present disclosure may either be a graphic processing unit (English: Graphic Processing Unit; abbreviation: GPU) in an intelligent terminal, or the intelligent terminal, which will not be defined herein.

In step 201: a picture sent by a user for being displayed in a first display layer is received.

In step 201, when a user needs to change the picture displayed in the first display layer, a picture needing to be changed is sent to a graphic processing unit through a display system of an intelligent terminal, so that the graphic processing unit receives the picture for being displayed in the first display layer.

For example: when the user opens the intelligent terminal and determines that a desktop background picture needs to be changed (i.e., the picture displayed in the first display layer), the user enters a desktop background management system (i.e., a display management system) at this moment, changes the desktop background picture, and triggers a “Confirm” or “Apply” button; at this moment, the graphic processing unit receives the picture sent by the user for being displayed in a desktop background display layer (i.e., the first display layer).

It should be herein noted that that the user may select other attributes while changing the desktop background picture, for example: a display mode of the picture, and a display resolution of the picture, or the like; and may also select an intelligent mixed attribute, and the intelligent mixed attribute herein refers to subsequent operations recorded in the embodiment of the present disclosure.

That is, when the graphic processing unit receives the picture sent by the user for being displayed in the first display layer, it is desirable to detect whether an intelligent mixed instruction is also received; if the intelligent mixed instruction is received, then subsequent operations are triggered to execute; and if no intelligent mixed instruction is received, then operation is executed according to the implementation manner of the prior art.

It should be herein noted that the implementation manner of the intelligent mixed attribute may be implemented through configuring an instruction, for example: configuring a WINDOW_FLAG_HH instruction (i.e., a window icon display instruction), and may also be implemented through other instructions, which will not be defined herein. Wherein, the intelligent mixed attribute may be added in the desktop background management system and synchronously displayed in a desktop background management display layer.

In step 202: display overlapping is performed on the picture and a second display layer including icons.

In step 202, when a picture used for change, the icons displayed in the second display layer and the display positions of the icons in the second display layer are displayed; at this moment, display overlapping is performed on the received picture and the second display layer including the icons, i.e., the icons displayed in the second display layer are mapped onto the picture needing to be changed according to a display mode.

It should be noted that the overlapping the display layer herein is namely to place the second display layer onto the first display layer; if the first display layer is called as a first picture layer, and the second display layer is called as a second picture layer, then the overlapping the display layer herein means to perform mixed picture layer operation on the first picture layer and the second display layer.

In step 203: the color contrast of the icon in a first area of the second display layer being overlapped onto the picture displayed in the first area of the first display layer is judged whether to be less than a first preset threshold; if the color contrast is less than the first preset threshold, then step 204 is performed; and if the color contrast is no less than the first preset threshold, then step 206 is performed.

The color contrast herein refers to the degree of closeness between two colors.

The icon of the second display layer displayed in the first area is determined whether to be recognized by the user through the color contrast when the icon in the first display area of the second display layer is overlapped onto the picture displayed in the first area of the first display layer.

Wherein, the closer the color of the icon in the first display area of the second display layer is to the color of the picture displayed in the first area of the first display layer, the smaller the color contrast of the icon in the first area of the second display layer being overlapped onto the picture displayed in the first area of the first display layer is; on the contrary, the larger the color contrast of the icon in the first area of the second display layer being overlapped onto the picture displayed in the first area of the first display layer is.

In step 204: when the color contrast of the icon in the first area of the second display layer being overlapped onto the picture displayed in the first area of the first display layer is less than the first preset threshold, the color contrast in the first area is adjusted, so that the adjusted color contrast is greater than the second preset threshold, the second threshold being greater than or equal to the first threshold.

In step 204, the manners for adjusting the color contrast in the first area include, but are not limited to the several manners as follows.

First manner:

a reverse operation is performed on the color of the picture displayed in the first area of the first display layer, and a color after performing the reverse operation is obtained; and

the color of the icon in the first display area of the second display layer is adjusted according to the obtained color, so that the adjusted color contrast of the icon in the first area being overlapped onto the picture displayed in the first area of the first display layer is greater than the second preset threshold.

To be specific, colors may be represented by “abgr” in a computer system. Wherein, a represents transparency, b represents blue, g represents green, and r represents red. When the color visibility of the icon of the second display layer in a first area being overlapped onto the picture displayed in the first area of the first display layer is less than the first preset threshold, the overlapped icon in the first area is determined to be difficultly recognized by the user, which causes inconvenience for the user to subsequently use the functional icon.

In order to improve the identifiability of the icon of the second display layer in a first area, a color mostly different from the color of the picture displayed in the first area of the first display layer may be determined by performing a reverse operation on the color of the picture displayed in the first area of the first display layer; in this way, the color of the icon in the first display area of the second display layer is adjusted according to the obtained color, so that the object of adjusting the color contrast in the first area is achieved, so that the adjusted color contrast of the icon in the first area being overlapped onto the picture displayed in the first area of the first display layer is greater than the second preset threshold, which may be beneficial for increasing the identifiability of the functional icon of the second display layer in the first area.

Second manner:

determining at least one color with a color contrast greater than the second preset threshold when overlapped onto the picture displayed in the first area of the first display layer, according to the color of the picture displayed in the first area of the first display layer;

one color is selected from the determined at least one color; and

the color of the icon in the first area is adjusted according to the selected color to achieve the object of adjusting the color contrast in the first area, so that the adjusted color contrast of the icon in the first area being overlapped onto the picture displayed in the first area of the first display layer is greater than the second preset threshold.

Third manner:

the color of the icon of the first display layer in the first area is adjusted according to the color of the icon in the first display area of the second display layer to achieve the object of adjusting the color contrast in the first area, so that the visibility of the functional icon in the first area being overlapped onto the adjusted picture displayed in the first area of the first display layer is greater than the second preset threshold.

Optionally, adjusting the color of the picture in the first area only may possibly cause the picture displayed in the first display layer to lose a sense of beauty; therefore, under the premise of ensuring that the color contrast of the icon in the first area being overlapped onto the adjusted picture displayed in the first area of the first display layer is greater than the second preset threshold, the method further includes a following step.

The color of the picture displayed in a second area of the first display layer is adjusted according to the adjusted color of the picture displayed in the first area of the first display layer, so that the color of the adjusted picture displayed in the second area of the first display layer is matched with the color of the adjusted picture displayed in the first area, wherein the first display layer includes the first area and the second area.

It should be noted that matching of the color refers to a smaller color contrast which will not cause apparent difference during displaying.

Fourth manner:

the color of the icon of the first display layer in the first area and the color of the icon in the first display area of the second display layer are adjusted respectively to achieve the object of adjusting the color contrast in the first area, so that the adjusted color contrast of the icon of the second display layer in the first area being overlapped onto the adjusted picture displayed in the first area of the first display layer is greater than the second preset threshold.

Optionally, when adjusting the color contrast in the first area of the second display layer, the method further includes:

when performing display overlapping on the picture with the second display layer including the icons, and when the color contrast of the icon in the second area of the second display layer being overlapped onto the picture displayed in the second area of the first display layer is less than the first preset threshold, the color of the icon in the second area is adjusted, so that the adjusted color contrast of the icon in the second area being overlapped onto the picture displayed in the second area of the first display layer is greater than the second preset threshold.

To be specific, the adjusting the color of the icon in the second area includes:

if the icon in the second area includes words and/or pictures, then the color of the words included in the icon is adjusted primarily, and the color of the pictures included in the icon is adjusted auxiliarily when adjusting the color of the icon in the second area.

It should be herein noted that most icons displayed in the second display layer belong to application icons which not only include pictures, but also include words for interpreting the pictures, for example: a “WeChat” icon including the Logo picture of WeChat and “WeChat” words; that is, the words for interpreting the icon may explain the function of the icon more preferably than the pictures. Therefore, once the words are not clear, the user cannot recognize the icon. Therefore, adjusting the color of the words in the application icon is preferred in the embodiment of the present disclosure, so that the user is ensured to be capable of recognizing the application icon even if the color of the icon is not adjusted, and the processing pressure of the system may be relieved as well.

In step 205: the first display layer including the pictures and the second display layer including the icons are displayed into a user interface UI in an overlapping manner according to the adjustment result.

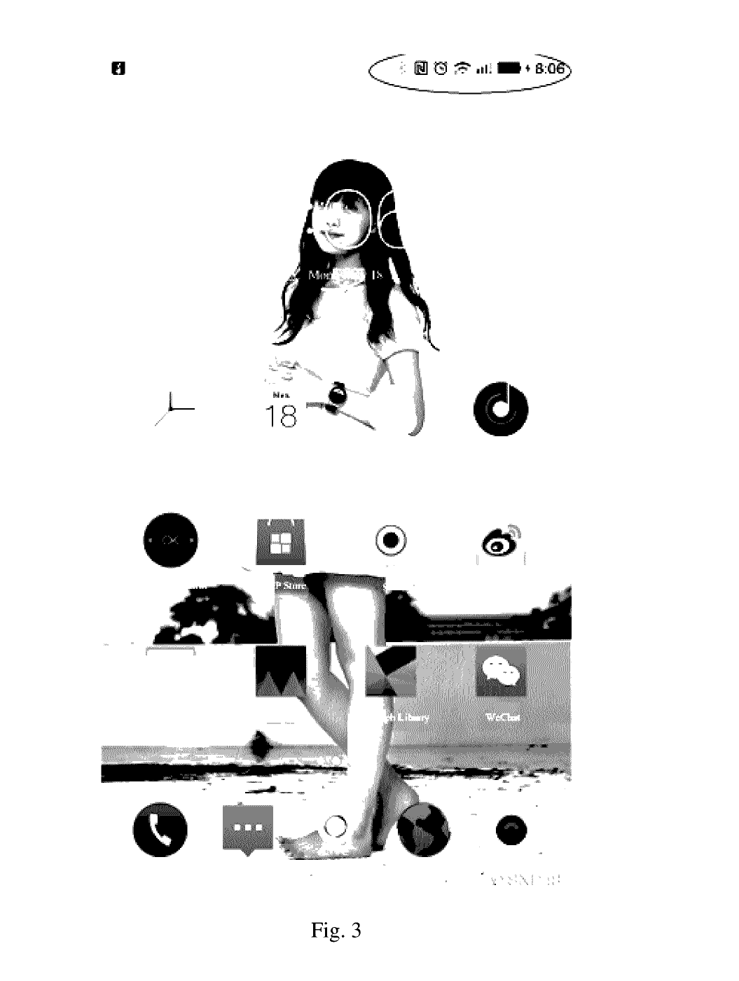

In step 205, FIG. 3 is a schematic diagram illustrating the picture and the functional icon displayed in the UI according to the adjustment result.

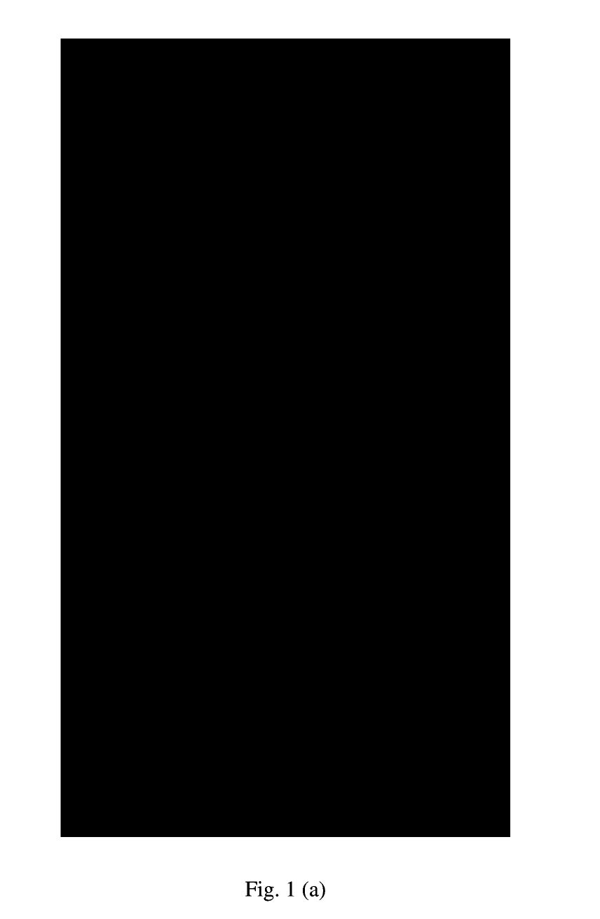

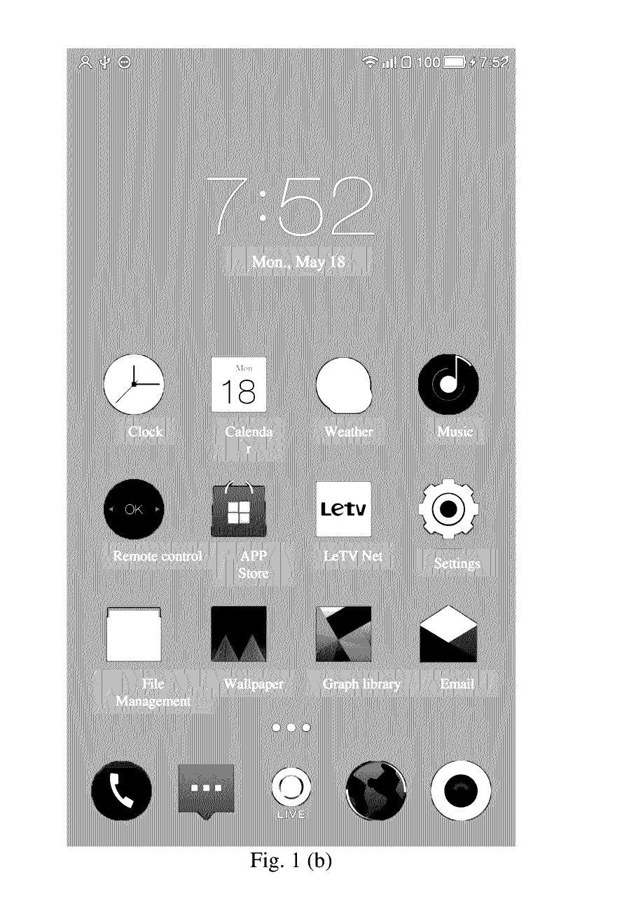

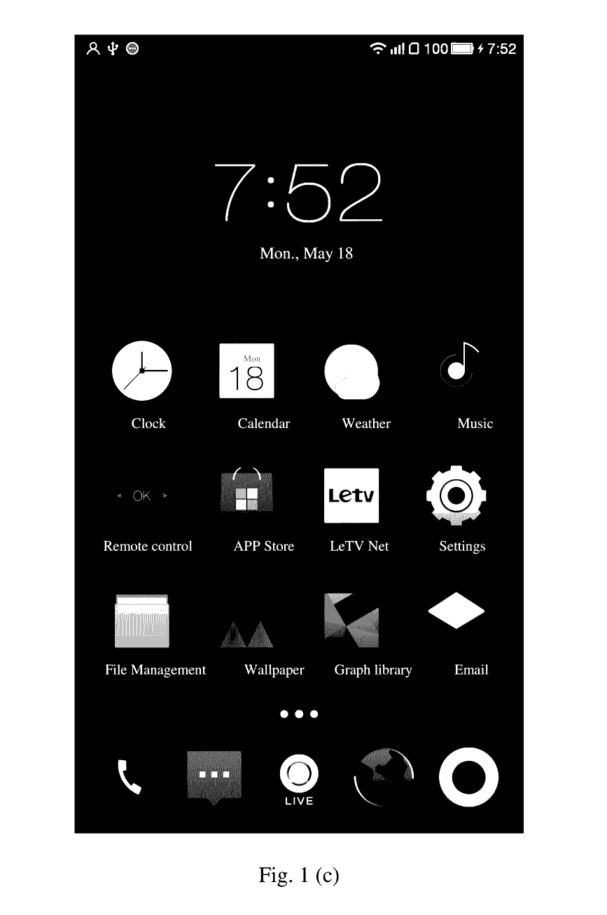

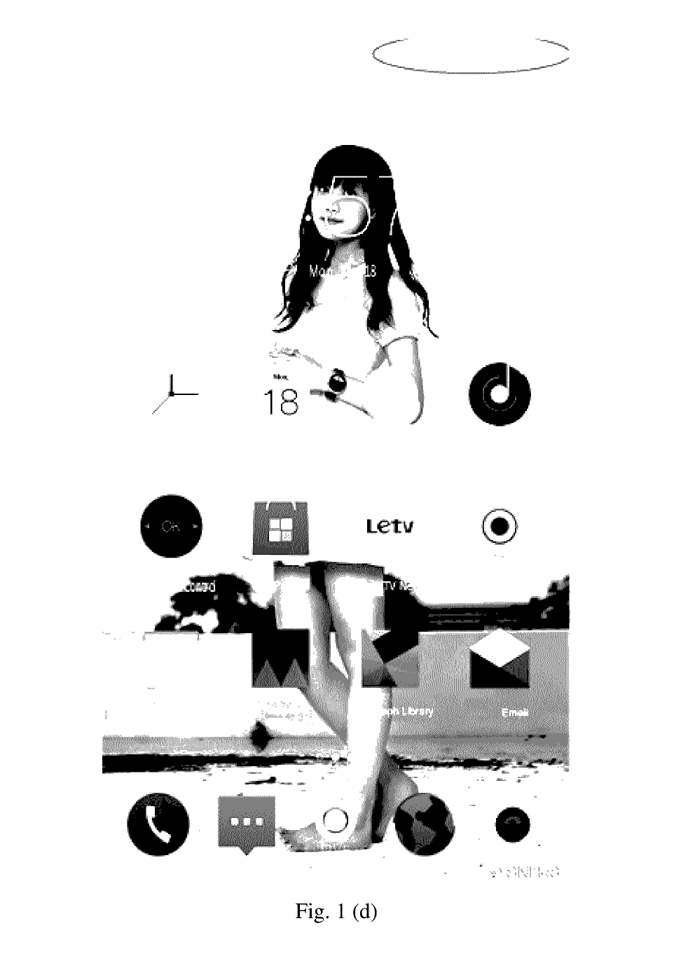

It may be seen from FIG. 3 that icons that cannot be displayed in the circles of FIG. 1(d) will be visible through the operations of steps 203 to step 205.

In step 206: the picture included in the first display layer is displayed according to the manner of the prior art.

The display method and the display device provided by the embodiments of the present disclosure receive the picture sent by the user for being displayed in the first display layer; perform display overlapping on the picture and the second display layer including icons; when the color contrast of the icon in the first area of the second display layer being overlapped onto the picture displayed in the first area of the first display layer is less than the first preset threshold, adjust the color contrast in the first area, so that the adjusted color contrast is greater than the second preset threshold, the second threshold being greater than or equal to the first threshold; and display the first display layer including the pictures and the second display layer including the icons into the user interface UI in an overlapping manner according to the adjustment result. In this way, for the same display area, when the color of the picture displayed in the first display layer and the color of the icon displayed in the second display layer are consistent, the color of the picture and/or the color of the icon is adjusted flexibly, so that the color contrast between the color of the picture and the color of the icon is increased, the display visibility of the icon is improved, the problem that the icon cannot be recognized by the user when the color of the picture displayed in the first display layer is consistent with the color of the icon displayed in the second display layer is solved, and the flexibility of the user for operating the intelligent terminal is increased.

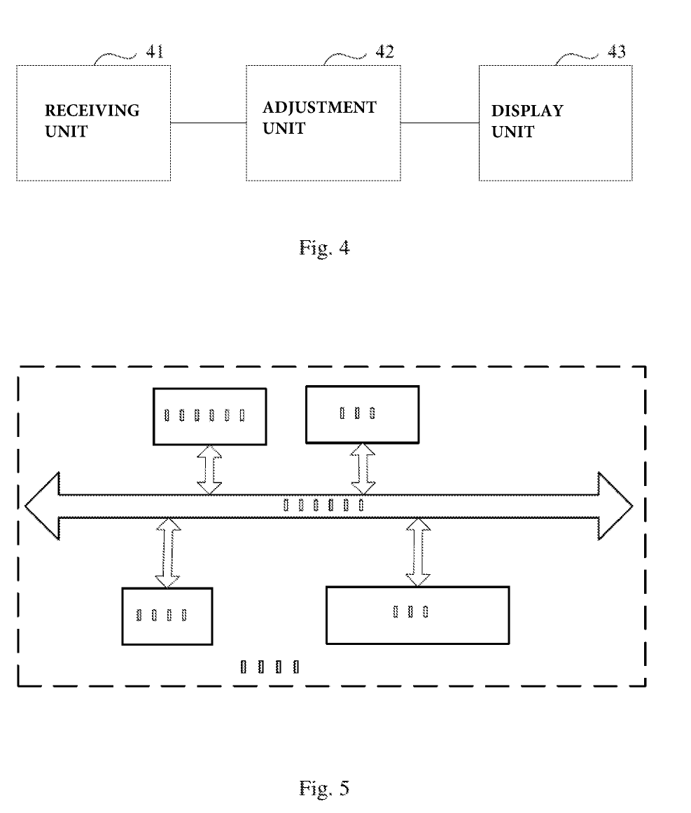

FIG. 4 is a structural schematic diagram of a display device provided by the embodiment of the present disclosure. The display device includes: a receiving unit 41, an adjustment unit 42 and a display unit 43, wherein:

the receiving unit 41 is configured to receive a picture sent by a user for being displayed in a first display layer;

the adjustment unit 42 is configured to perform display overlapping on the picture and a second display layer including icons; and when the color contrast of the icon in a first area of the second display layer being overlapped onto the picture displayed in the first area of the first display layer is less than a first preset threshold, adjust the color contrast in the first area, so that the adjusted color contrast is greater than a second preset threshold, the second threshold being greater than or equal to the first threshold; and

the display unit 43 is configured to display the first display layer including the pictures and the second display layer including the icons into a user interface UI in an overlapping manner according to the adjustment result.

Specifically, the adjusting the color contrast in the first area by the adjustment unit 42 particularly includes:

performing a reverse operation on the color of the picture displayed in the first area of the first display layer, and obtaining a color after performing the reverse operation; and

adjusting the color of the icon in the first area according to the obtained color, so that the adjusted color contrast of the icon in the first area being overlapped onto the picture displayed in the first area of the first display layer is greater than the second preset threshold.

Specifically, the adjusting the color contrast in the first area by the adjustment unit 42 particularly includes:

determining at least one color with a color contrast greater than the second preset threshold when overlapped onto the picture displayed in the first area of the first display layer, according to the color of the picture displayed in the first area of the first display layer;

selecting one color from the determined at least one color; and

adjusting the color of the icon in the first area according to the selected color, so that the adjusted color contrast of the icon in the first area being overlapped onto the picture displayed in the first area of the first display layer is greater than the second preset threshold.

Specifically, the adjusting the color contrast in the first area by the adjustment unit 42 particularly includes:

adjusting the color of the picture displayed in the first area of the first display layer according to the color of the icon in the first display area of the second display layer, so that the color contrast of the icon in the first area being overlapped onto the adjusted picture displayed in the first area of the first display layer is greater than the second preset threshold.

Optionally, the adjustment unit 42 is also configured to adjust the color of the picture displayed in a second area of the first display layer according to the adjusted color of the picture displayed in the first area of the first display layer, so that the color of the adjusted picture displayed in the second area of the first display layer is matched with the color of the adjusted picture displayed in the first area, wherein the first display layer includes the first area and the second area.

Specifically, the adjusting the color contrast in the first area by the adjustment unit 42 particularly includes:

adjusting the color of the picture displayed in the first area of the first display layer and adjusting the color of the icon in the first display area of the second display layer respectively, so that the color contrast of the adjusted icon in the first area of the second display layer being overlapped onto the adjusted picture displayed in the first area of the first display layer is greater than the second preset threshold.

Optionally, the adjustment unit 42 is also configured to, when performing display overlapping on the picture with the second display layer including the icons, and when the color contrast of the icon in a second area of the second display layer being overlapped onto the picture displayed in the second area of the first display layer is less than the first preset threshold, adjust the color of the icon in the second area, so that the adjusted color contrast of the icon in the second area being overlapped onto the picture displayed in the second area of the first display layer is greater than the second preset threshold.

Specifically, the adjusting the color of the icon in the second area by the adjustment unit 42 particularly includes:

if the icon in the second area includes words and/or pictures, then primarily adjusting the color of the words included in the icon, and auxiliarily adjusting the color of the pictures included in the icon when adjusting the color of the icon in the second area.

Related functional modules above of the embodiment of the present disclosure can be implemented through a graphic processing unit.

For the same display area, when the color of the picture displayed in the first display layer and the color of the icon displayed in the second display layer by the graphic processing unit are consistent, the color of the picture and/or the color of the icon is adjusted flexibly, so that the color contrast between the color of the picture and the color of the icon is increased, the display visibility of the icon is improved, the problem that the icon cannot be recognized by the user when the color of the picture displayed in the first display layer is consistent with the color of the icon displayed in the second display layer is solved, and the flexibility of the user for operating the intelligent terminal is increased.

FIG. 5 is a structural schematic diagram of a display device provided by the embodiment of the present disclosure. To be specific, the display device may be a PC, a smartphone, a PAD (tablet), a two-in-one tablet PC, or the like. As shown in FIG. 5, the display device includes: a memory and a processor; wherein the memory is stored with an instruction of implementing the display method according to the foregoing display method as shown in FIG. 2, and wherein the processor, for example, is a graphic processing unit; and the following steps may be performed when the processor invokes the instruction of the display method stored in the memory:

receiving a picture sent by a user for being displayed in a first display layer;

perform display overlapping on the picture and the second display layer including icons;

when the color contrast of the icon in a first area of the second display layer being overlapped onto the picture displayed in the first area of the first display layer is less than a first preset threshold, adjusting the color contrast in the first area, so that the adjusted color contrast is greater than a second preset threshold, the second threshold being greater than or equal to the first threshold; and

displaying the first display layer including the pictures and the second display layer including the icons into a user interface UI in an overlapping manner according to the adjustment result.

Wherein, when adjusting the color contrast in the first area by the processor it particularly includes:

performing a reverse operation on the color of the picture displayed in the first area of the first display layer, and obtaining a color after performing the reverse operation; and

adjusting the color of the icon in the first area according to the obtained color, so that the adjusted color contrast of the icon in the first area being overlapped onto the picture displayed in the first area of the first display layer is greater than the second preset threshold.

Wherein, when adjusting the color contrast in the first area by the processor it particularly includes:

determining at least one color with a color contrast greater than the second preset threshold when overlapped onto the picture displayed in the first area of the first display layer, according to the color of the picture displayed in the first area of the first display layer;

selecting one color from the determined at least one color; and

adjusting the color of the icon in the first area according to the selected color, so that the adjusted color contrast of the icon in the first area being overlapped onto the picture displayed in the first area of the first display layer is greater than the second preset threshold.

Wherein, when adjusting the color contrast in the first area by the processor it particularly includes:

adjusting the color of the picture displayed in the first area of the first display layer according to the color of the icon in the first display area of the second display layer, so that the color contrast of the icon in the first area being overlapped onto the adjusted picture displayed in the first area of the first display layer is greater than the second preset threshold.

The following steps may be performed when the processor invokes the instruction of the display method stored in the memory:

adjusting the color of the picture displayed in a second area of the first display layer according to the adjusted color of the picture displayed in the first area of the first display layer, so that the color of the adjusted picture displayed in the second area of the first display layer is matched with the color of the adjusted picture displayed in the first area, wherein the first display layer includes the first area and the second area.

When adjusting the color contrast in the first area by the processor it particularly includes:

adjusting the color of the picture displayed in the first area of the first display layer and adjusting the color of the icon in the first display area of the second display layer respectively, so that the color contrast of the adjusted icon in the first area of the second display layer being overlapped onto the adjusted picture displayed in the first area of the first display layer is greater than the second preset threshold.

The following steps may be performed when the processor invokes the instruction of the display method stored in the memory:

when performing display overlapping on the picture with the second display layer including the icons, and when the color contrast of the icon in a second area of the second display layer being overlapped onto the picture displayed in the second area of the first display layer is less than the first preset threshold, adjusting the color of the icon in the second area, so that the adjusted color contrast of the icon in the second area being overlapped onto the picture displayed in the second area of the first display layer is greater than the second preset threshold.

When adjusting the color contrast in the first area by the processor it particularly includes:

if the icon in the second area includes words and/or pictures, then primarily adjusting the color of the words included in the icon, and auxiliarily adjusting the color of the pictures included in the icon when adjusting the color of the icon in the second area.

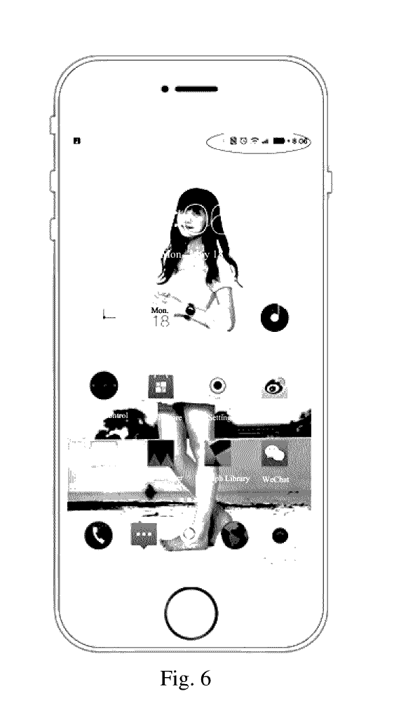

FIG. 6 is a schematic diagram illustrating a user interface of a display device provided by the embodiment of the present disclosure. As shown in FIG. 6, the display device, for example, is a smartphone, and a user interface of the smartphone as shown in the figure is a schematic diagram of pictures and functional icons displayed in an overlapping manner according to the adjustment result.

In a typical configuration, the display device includes one or more processors (CPU), input/output interface(s), network interface(s) and a memory.

The memory may include such forms as a volatile memory, a random access memory (RAM) and/or a non-volatile memory in a computer-readable medium, such as a read-only memory (ROM) (ROM) or a flash memory (flash RAM). The memory is an example of the computer-readable medium.

The computer-readable medium includes nonvolatile and volatile as well as movable and immovable medium, which can implement information storage through any method or technology. The information may be a computer-readable instruction, a data structure, a program module, or other data. The examples of the computer storage medium includes, but are not limited to a phase change memory (PRAM), a static random access memory (SRAM), a dynamic random access memory (DRAM), other type random access memory (RAM), a read-only memory (ROM) (ROM), an electrically erasable programmable read-only memory (EEPROM), a flash memory or other memory technology, a compact disk read-numeral only memory (CD-ROM), a digital versatile disk (DVD) or other optical storage and videocassette, magnetic tape, disk storage or other magnetic storage device or any other non-transmission medium, which can be configured to store information that can be accessed by the computing device. According to the definition herein, the computer-readable medium does not include a non-transitory computer-readable media (transitory media), such as modulated data signal and carrier wave.

Certain terms are used throughout the description and following claims to refer to particular components. Those skilled in the art will appreciate, hardware manufacturers may refer to a component by different names. This description and following claims do not intend to distinguish between components that differ in name but in function. In the throughout description and following claims, the term “include” is used in an open-ended fashion, and thus should be interpreted to mean “include, but not limited to . . . ”. “Approximately” refers to that in an acceptable error range, those skilled in the art can solve the technical problem in a certain error range and substantially reach the technical effects. Moreover, the term “couple” herein includes any direct and indirect electrical coupling ways. Accordingly, if it is described herein that a first device is coupled to a second device, it means that the first device can be directly and electrically coupled to the second device, or indirectly and electrically coupled to the second device through other devices or coupling ways. The subsequent description refers to the preferred embodiments for implementing the present application; however, the description aims at explaining the general principle of the present application, but is not intended to define the scope of the present application. The protection scope of the present application shall be subjected to the claims appended.

It should also be noted that the terms “comprise”, “comprising” or any other variation thereof, are intended to cover a non-exclusive inclusion, such that a commodity or system that comprises a list of elements does not include only those elements but may include other elements not expressly listed or inherent to such commodity or system. An elements defined by a statement of “comprise a . . . ”, does not, without more constraints, preclude the existence of additional identical elements in the commodity or system that comprises the element.

The explanation above shows and describes a plurality of preferred embodiments of the present disclosure, but as previously mentioned, it should be understood that the present disclosure is not limited to the forms disclosed herein, and shall not be deemed as an exclusion to other embodiments, but can be applied to various other combinations, amendments and circumstances, and can be modified through the foregoing teaching or technologies or knowledge of related arts within the scope of the disclosure concept herein. While modifications and changes made by those skilled in the art without departing from the spirit and scope of the present disclosure shall all fall within the protection scope of the claims of the present disclosure appended.

What is claimed is:

1. A display method, comprising:
receiving a picture sent by a user for being displayed in a first display layer;
overlapping the picture and a second display layer comprising icons;
when the color contrast of the icon in a first area of the second display layer being overlapped onto the picture displayed in a first area of the first display layer is less than a first preset threshold, adjusting the color contrast in the first area, so that the adjusted color contrast is greater than a second preset threshold, the second threshold being greater than or equal to the first threshold; and
displaying the first display layer comprising the pictures and the second display layer comprising the icons into a user interface UI in an overlapping manner according to the adjustment result.

2. The display method according to claim 1, wherein the adjusting the color contrast in the first area comprises:
performing a reverse operation on the color of the picture displayed in the first area of the first display layer, and obtaining a reversed color after performing the reverse operation; and
adjusting the color of the icon in the first area according to the obtained reversed color, so that the adjusted color contrast of the icon in the first area being overlapped onto the picture displayed in the first area of the first display layer is greater than the second preset threshold.

3. The display method according to claim 1, wherein the adjusting the color contrast in the first area comprises:
determining at least one color with a color contrast greater than the second preset threshold when overlapped onto the picture displayed in the first area of the first display layer, according to the color of the picture displayed in the first area of the first display layer;
selecting one color from the determined at least one color; and
adjusting the color of the icon in the first area according to the selected color.

4. The display method according to claim 1, wherein the adjusting the color contrast in the first area comprises:
adjusting the color of the picture displayed in the first area of the first display layer according to the color of the icon in the first display area of the second display layer, so that the color contrast
of the icon in the first area being overlapped onto the adjusted picture displayed in the first area of the first display layer is greater than the second preset threshold.

5. The display method according to claim 4, further comprising:
adjusting the color of the picture displayed in a second area of the first display layer according to the adjusted color of the picture displayed in the first area of the first display layer, so that the color of the adjusted picture displayed in the second area of the first display layer is matched with the color of the adjusted picture displayed in the first area, wherein the first display layer comprises the first area and the second area.

6. The display method according to claim 1, wherein the adjusting the color contrast in the first area comprises:
adjusting the color of the picture displayed in the first area of the first display layer and adjusting the color of the icon in the first display area of the second display layer respectively, so that the color contrast of the adjusted icon in the first area of the second display layer being overlapped onto the adjusted picture displayed in the first area of the first display layer is greater than the second preset threshold.

7. The display method according to claim 1, further comprising:
when performing display overlapping on the picture with the second display layer comprising the icons, and when the color contrast of the icon in a second area of the second display layer being overlapped onto the picture displayed in the second area of the first display layer is less than the first preset threshold, adjusting the color of the icon in the second area, so that the adjusted color contrast of the icon in the second area being overlapped onto the picture displayed in the second area of the first display layer is greater than the second preset threshold.

8. The display method according to claim 7, wherein the adjusting the color of the icon in the second area comprises:
if the icon in the second area comprises words and/or pictures, then primarily adjusting the color of the words comprised in the icon, and auxiliarily adjusting the color of the pictures comprised in the icon when adjusting the color of the icon in the second area.

9. A display device, comprising:
at least one memory and at least one processor, the at least one processor comprises a graphic processor;
the at least one memory communicably connected with the at least one processor for storing instructions executable by the at least one processor, wherein execution of the instructions by the at least one processor causes the at least one processor to:
receiving a picture sent by a user for being displayed in a first display layer;
overlapping the picture and a second display layer comprising icons;
when the color contrast of the icon in a first area of the second display layer being overlapped onto the picture displayed in the first area of the first display layer is less than a first preset threshold, adjusting the color contrast in the first area, so that the adjusted color contrast is greater than a second preset threshold, the second threshold being greater than or equal to the first threshold; and
displaying the first display layer comprising the pictures and the second display layer comprising the icons into a user interface UI in an overlapping manner according to the adjustment result.

10. The display device according to claim 9, wherein the adjusting the color contrast in the first area by the processor particularly comprises:
performing a reverse operation on the color of the picture displayed in the first area of the first display layer, and obtaining a reversed color after performing the reverse operation; and
adjusting the color of the icon in the first area according to the obtained reversed color, so that the adjusted color contrast of the icon in the first area being overlapped onto the picture displayed in the first area of the first display layer is greater than the second preset threshold.

11. The display device according to claim 9, wherein the adjusting the color contrast in the first area by the processor particularly comprises:
determining at least one color with a color contrast greater than the second preset threshold when overlapped onto the picture displayed in the first area of the first display layer, according to the color of the picture displayed in the first area of the first display layer;
selecting one color from the determined at least one color; and
adjusting the color of the icon in the first area according to the selected color.

12. The display device according to claim 9, wherein the adjusting the color contrast in the first area by the processor particularly comprises:
adjusting the color of the picture displayed in the first area of the first display layer according to the color of the icon in the first display area of the second display layer, so that the color contrast of the icon in the first area being overlapped onto the adjusted picture displayed in the first area of the first display layer is greater than the second preset threshold.

13. The display device according to claim 9, wherein the following steps may also be performed when invoking the instruction of the display method stored in the memory by the processor:
adjusting the color of the picture displayed in a second area of the first display layer according to the adjusted color of the picture displayed in the first area of the first display layer, so that the color of the adjusted picture displayed in the second area of the first display layer is matched with the color of the adjusted picture displayed in the first area, wherein the first display layer comprises the first area and the second area.

14. The display device according to claim 9, wherein the adjusting the color contrast in the first area by the processor particularly comprises:
adjusting the color of the picture displayed in the first area of the first display layer and adjusting the color of the icon in the first display area of the second display layer respectively, so that the color contrast of the adjusted icon in the first area of the second display layer being overlapped onto the adjusted picture displayed in the first area of the first display layer is greater than the second preset threshold.

15. The display device according to claim 9, wherein the following steps may also be performed when invoking the instruction of the display method stored in the memory by the processor:
when performing display overlapping on the picture with the second display layer comprising the icons, and when the color contrast of the icon in a second area of the second display layer being overlapped onto the picture displayed in the second area of the first display layer is less than the first preset threshold, adjusting the color of the icon in the second area, so that the adjusted color contrast of the icon in the second area being overlapped onto the picture displayed in the second area of the first display layer is greater than the second preset threshold.

16. The display device according to claim 15, wherein the adjusting the color of the icon in the second area by the processor particularly comprises:
if the icon in the second area comprises words and/or pictures, then primarily adjusting the color of the words comprised in the icon, and auxiliarily adjusting the color of the pictures comprised in the icon when adjusting the color of the icon in the second area.

17. A non-transitory computer-readable storage medium storing executable instructions that, when executed by a display device, cause the display device to:
receive a picture sent by a user for being displayed in a first display layer;
overlap the picture and a second display layer comprising icons;
when the color contrast of the icon in a first area of the second display layer being overlapped onto the picture displayed in a first area of the first display layer is less than a first preset threshold, adjust the color contrast in the first area, so that the adjusted color contrast is greater than a second preset threshold, the second threshold being greater than or equal to the first threshold; and
display the first display layer comprising the pictures and the second display layer comprising the icons into a user interface UI in an overlapping manner according to the adjustment result.

18. The non-transitory computer-readable storage medium according to claim 17, wherein the adjusting the color contrast in the first area comprises:
performing a reverse operation on the color of the picture displayed in the first area of the first display layer, and obtaining a reversed color after performing the reverse operation; and
adjusting the color of the icon in the first area according to the obtained reversed color, so that the adjusted color contrast of the icon in the first area being overlapped onto the picture displayed in the first area of the first display layer is greater than the second preset threshold.

19. The non-transitory computer-readable storage medium according to claim 17, wherein the adjusting the color contrast in the first area comprises:
determining at least one color with a color contrast greater than the second preset threshold when overlapped onto the picture displayed in the first area of the first display layer, according to the color of the picture displayed in the first area of the first display layer;
selecting one color from the determined at least one color; and
adjusting the color of the icon in the first area according to the selected color.

20. The non-transitory computer-readable storage medium according to claim 17, wherein the adjusting the color contrast in the first area comprises:
adjusting the color of the picture displayed in the first area of the first display layer according to the color of the icon in the first display area of the second display layer, so that the color contrast of the icon in the first area being overlapped onto the adjusted picture displayed in the first area of the first display layer is greater than the second preset threshold.
